(19) United States
(12) Patent Application Publication
(10) Pub. No.: US 2014/0109084 A1
(43) Pub. Date: Apr. 17, 2014

(54) Systems and Methods for File Processing

(71) Applicant: TENCENT TECHNOLOGY (SHENZHEN) COMPANY LIMITED, Shenzhen (CN)

(72) Inventors: Yanhui Shen, Shenzhen (CN); Xuehui Zhang, Shenzhen (CN)

(73) Assignee: TENCENT TECHNOLOGY (SHENZHEN) COMPANY LIMITED, Shenzhen (CN)

(21) Appl. No.: 14/097,897

(22) Filed: Dec. 5, 2013

Related U.S. Application Data
(63) Continuation of application No. PCT/CN2013/082566, filed on Aug. 29, 2013.

(30) Foreign Application Priority Data
Aug. 30, 2012 (CN) 201210315043.X

(51) Int. Cl. G06F 9/445

(52) U.S. Cl. CPC G06F 8/61
USPC 717/178

(57) ABSTRACT

Systems and methods are provided for opening an unknown file. For example, whether a software matching with an unknown file is locally installed is detected; in response to the software being locally installed, the unknown file is opened using the installed software; and in response to the software not being locally installed, the software is downloaded and the unknown file is opened using the downloaded software.

### CROSS-REFERENCES TO RELATED APPLICATIONS

This application claims priority to Chinese Patent Application No. 201210315043.X, filed Aug. 30, 2012, incorporated by reference herein for all purposes.

### BACKGROUND OF THE INVENTION

The present invention is directed to computer technology. More particularly, the invention provides systems and methods for information processing. Merely by way of example, the invention has been applied to computer files. But it would be recognized that the invention has a much broader range of applicability.

After a certain software is installed, an association between the installed software and types of flies that the installed software can open may be written into a. registry of an operating system (e.g., Windows). In response to an instruction to open a file, the operating system (e.g., Windows) searches for software associated with the file type in the system registry and opens the file using the software. If no software associated with the file type can be found, such a file is an unknown file to the operating system (e.g., Windows).

Conventionally, in response to an instruction to open an unknown file, the operating system (e.g., Windows) usually generates a popup prompt window to indicate that the operating system cannot open this file and provide two options: 1, use the Web service to find a correct program; 2, select a program from a list of installed programs. Oftentimes, a user cannot find the correct program from the list of installed programs. If the user selects using the Web service to find the correct program, the user interface may switch to a webpage in which information related to the unknown file may be shown. The user may further switch from the current webpage to a search page and the user may need to search for a proper link from a large number of webpage links provided in the search page. Once the user clicks on a certain link and is connected to a webpage associated with the link, the user often needs to search for an entry point for downloading an installer program, and then performs a series of operations required during the installation process. After the installation completes, the user may need to go back to a folder containing the unknown file and try to open the unknown file manually.

In the conventional method, many different user interfaces often need to be visited during the process from receiving the instruction to open the unknown file to finally opening the file. The user usually needs to participate in the whole process and perform multiple operations. In addition, the process often takes a long time. It is usually not efficient to open an unknown file using the conventional method.

Hence it is highly desirable to improve the tee es for opening unknown files.

### BRIEF SUMMARY OF THE INVENTION

The present invention is directed to computer technology. More particularly, the invention provides systems and methods for information processing. Merely by way of example, the invention has been applied to computer files. But it would be recognized that the invention has a much broader range of applicability.

According to one embodiment, a method is provided for opening an unknown file. For example, whether a software matching with an unknown file is locally installed is detected; in response to the software being locally installed, the unknown file is opened using the installed software; and in response to the software not being locally installed, the software is downloaded and the unknown file is opened using the downloaded software.

According to another embodiment, a device for opening an unknown file includes a local-software-detection module, a download module, and a file-opening module. The local-software-detection module is configured to detect whether a software matching with an unknown file is locally installed. The download module is configured, in response to the software not being locally installed, to download the software. The file-opening module is configured, in response to the software being locally installed, to open the unknown file with the installed software and, in response to the software not being locally installed, open the unknown file with the downloaded software.

According to yet another embodiment, a method is provided for opening an unknown file. For example, whether a software matching with an unknown file is locally installed is detected; in response to the software being locally installed, the unknown file is opened using the installed software; and in response to the software not being locally installed, the software is downloaded and the unknown file is opened using the downloaded software. The opening the unknown file using the installed software include, repairing an association between a file type related to the unknown file and the installed software in a registry of an operating system; providing an instruction to the operating system to open the unknown file; and in response to failing to repair the association between the file type related to the unknown file and the installed software in the registry of the operating system, downloading the software and opening the unknown file using the downloaded software. The repairing an association between a file type related to the unknown file and the installed software in a registry of an operating system includes: displaying a prompt for repairing the association between the file type related to the unknown file and the installed software in the registry of the operating system; and receiving a confirmation for repairing the association between the file type related to the unknown file and the installed software. The opening the unknown file using the downloaded software includes: installing the downloaded software; setting an association between a file type related to the unknown file and the downloaded software; and providing an instruction to the operating system to open the unknown file. The downloading the software includes: displaying a prompt for downloading the software; and receiving a confirmation for downloading the software.

In one embodiment, a device for opening an unknown file includes a local-software-detection module, a download module, a file-opening module, a display module, and an instruction-fetching module, The local-software-detection module is configured to detect whether a software matching with an unknown file is locally installed. The download module is configured, in response to the software not being locally installed, to download the software. The file-opening module is configured, in response to the software being locally installed, to open the unknown file with the installed software and, in response to the software not being locally installed, open the unknown file with the downloaded software. The display module is configured to display a prompt for repairing an association between a file type related to the unknown file and the installed software in a registry of an operating system and display a prompt for downloading the software. The instruction-fetching module is configured to receive a confirmation for repairing the association between the file type related to the unknown file and the installed software in the registry of the operating system and receive a confirmation for downloading the software. The file-opening module includes a registry-writing module, an instruction-generation module, and an installation module. The registry-writing module is configured, in response to the software being locally installed, to repair the association between the file type related to the unknown file and the installed software in the registry of the operating system and, in response to the software not being locally installed, set the association between the file type related to the unknown file and the downloaded software in the registry of the operating system. The instruction-generation module is configured to provide an instruction to the operating system to open the unknown file. The installation module is configured, in response to the software not being locally installed, to install the downloaded software. The download module is further configured, in response to failing to repair the association between the file type related to the unknown file and the installed software in the registry of the operating system, to download the software. The file-opening module is further configured, in response to failing to repair the association between the file type related to the unknown file and the installed software in the registry of the operating system, to open the unknown file using the downloaded software.

In another embodiment, a non-transitory computer readable storage medium comprises programming instructions for opening an unknown file. The programming instructions are configured to cause a processing system to execute operations comprising: detecting whether a software matching with an unknown file is locally installed; in response to the software being locally installed, opening the unknown file using the installed software; and in response to the software not being locally installed, downloading the software and opening the unknown file using the downloaded software.

In yet another embodiment, a compute implemented system for opening an unknown file includes one or more data processors and a computer-readable storage medium. The computer-readable storage medium is encoded with instructions for commanding the data processors to execute operations including: detecting whether a software matching with an unknown file is locally installed; in response to the software being locally installed, opening the unknown file using the installed software; and in response to the software not being locally installed, downloading the software and opening the unknown file using the downloaded software.

Depending upon embodiment, one or more benefits may be achieved. These benefits and various additional objects, features and advantages of the present invention can be fully appreciated with reference to the detailed description and accompanying drawings that follow.

For example, the systems and methods described herein may be configured to open an unknown file, where user participation is barely needed to use locally installed software to open the unknown file or automatically download a matching software to open the unknown file, in order to increase the convenience fear user operations and improve the efficiency of opening an unknown file. In another example, the systems and methods described herein may be configured to open an unknown file, where interface switching is rarely needed in the process of opening the unknown file so as to facilitate user operations. In yet another example, the systems and methods described herein may be configured to implement one or more prompt windows for opening an unknown file, where different prompt windows are closely related so as to conveniently guide users to perform relevant operations.

### BRIEF DESCRIPTION OF THE DRAWINGS

FIG. 1 is a simplified diagram showing a method for opening an unknown file according to one embodiment of the present invention,

FIG. 2 is a simplified diagram showing a method for opening an unknown file according to another embodiment of the present invention.

FIG. 3 is a simplified diagram of a prompt window showing one or more recommended software for opening an unknown file according to one embodiment of the present invention.

FIG. 4 is a simplified diagram of a prompt window showing that a software is being downloaded according to one embodiment of the present invention.

FIG. 5 is a simplified diagram of a prompt window showing the completion of installing a software according to one embodiment of the present invention.

FIG. 6 is a simplified diagram of a prompt window for repairing an association between a type of an unknown file and a matching software according to one embodiment of the present invention.

FIG. 7 is a simplified diagram of a prompt window showing that a process for repairing an association between a type of an unknown file and a matching software is ongoing according to one embodiment of the present invention.

FIG. 8 is a simplified diagram of a. prompt window showing that a process for repairing an association between a type of an unknown file and a matching software has completed according to one embodiment of the present invention.

FIG. 9 is a simplified diagram of a prompt window showing that a process or repairing an association between a type of an unknown file and a matching software has failed according to one embodiment of the present invention.

FIG. 10 is a simplified diagram showing a device for opening an unknown file according to one embodiment of the present invention.

FIG. 11 is a simplified diagram showing certain components of a file-opening module as part of the device as shown in FIG. 10 according to one embodiment of the present invention.

FIG. 12 is a simplified diagram showing certain components of a file-opening module as part of the device as shown in FIG. 10 according to another embodiment of the present invention.

FIG. 13 is a simplified diagram showing a device for opening an unknown file according to another embodiment of the present invention.

### DETAILED DESCRIPTION OF THE INVENTION

The present invention is directed to computer technology. More particularly, the invention provides systems and methods for information processing. Merely by way of example, the invention has been applied to computer files. But it would be recognized that the invention has a much broader range of applicability.

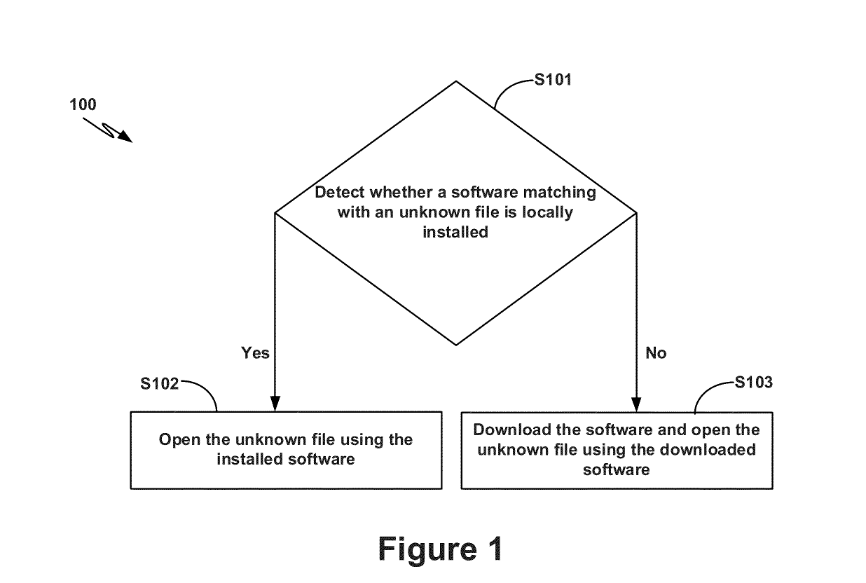

FIG. 1 is a simplified diagram showing a method for opening an unknown file according to one embodiment of the present invention. This diagram is merely an example, which should not unduly limit the scope of the claims. One of ordinary skill in the art would recognize many variations, alternatives, and modifications. The method 100 for opening an unknown file includes at least a process S101 for detecting whether a software matching with an unknown file is locally installed; if the software matching with the unknown file is locally installed, then a process S102 may be executed; if not, then a process S103 may be executed.

When an operating system (e.g., Windows) receives an instruction to open an unknown file, the operating system may send an instruction to generate a pop-up prompt window and a prompt window pops up in response. It may be indicated in the prompt window that the file cannot be opened, and two options may be provided—“use the Web service to find a correct program,” and “select a program from a list of installed programs.”

According to one embodiment, it is detected whether an instruction to open an unknown file is received. For example, if the instruction to open an unknown file is received, a system instruction to generate a pop-up prompt window from the operating system (e.g., Windows) is intercepted to prevent the prompt window from popping up. The process S101 is then executed, in some embodiments.

Specifically, information associated with a software that matches with the unknown file is obtained, including an identification of an application program that can open the unknown file, according to certain embodiments. For example, it is detected whether configuration files of locally installed software contain extensions related to the unknown file. As an example, if the configuration files of a particular software co in such extensions, this software matches with the unknown file.

Furthermore, it is detected whether the matching software is included in a software list within a registry of the operating system or included in an application list within the Start menu, according to another embodiment. For example, if the matching software is found in either the software list or the application list, the matching software has been locally installed.

According to yet another embodiment, at the process S102, the unknown file is opened using the installed matching software. For example, an association between the file type of the unknown file and the matching software within the system registry is repaired, and then an instruction is sent to the operating system to open the unknown file.

When the operating system (e.g., Windows) receives the instruction to open a certain file, the operating system may search in the system registry for a software associated with the type of the file to be opened, and run the software to open the file. In one embodiment, at the process S102, the association between the file type of the unknown file and the installed matching software in the system registry has been repaired. For example, the operating system runs the matching software to open the unknown file. In another embodiment, if the process for repairing the association between the file type related to the unknown file and the installed matching software in the system registry has failed, the matching software is downloaded and the unknown file is then opened using the downloaded matching software.

Referring to FIG. 1, at the process S103, if the software matching with the unknown file is not locally installed, the matching software is downloaded and the unknown file is opened using the downloaded software, according to certain embodiments.

Specifically, in one embodiment, information associated with relationship between file types and corresponding software (i.e., the software capable of opening files of one or more file types) is saved in advance. For example, a software that corresponds to the file type of the unknown file and the identification information of such a matching software are obtained based on the information associated with the relationship between file types and corresponding software, at the process S103.

In another embodiment, information associated with relationship between software identification information and corresponding download addresses is saved in advance. For example, a download address that corresponds to the identification information of the matching software is located and the matching software is downloaded from the located download address, at the process S103.

Furthermore, the downloaded matching software is installed, in some embodiments. For example, an association between the file type of the unknown file and the downloaded matching software is set in the system registry, and an instruction is provided to the operating system to open the unknown file.

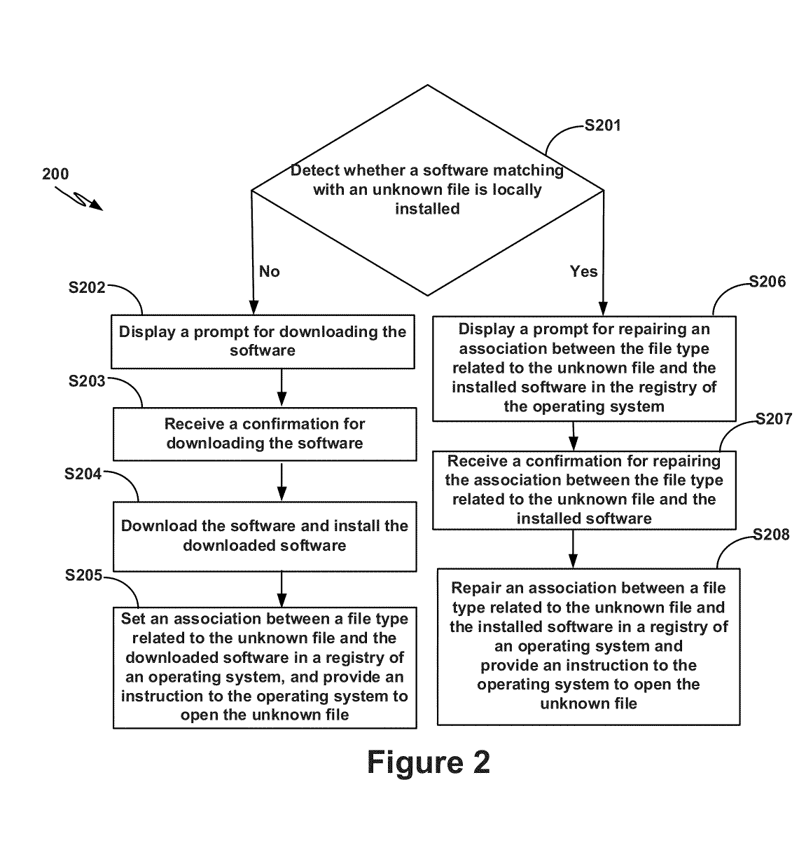

FIG. 2 is a simplified diagram showing a method for opening an unknown file according to another embodiment of the present invention. This diagram is merely an example, which should not unduly limit the scope of the claims. One of ordinary skill in the art would recognize many variations, alternatives, and modifications. The method 200 for opening an unknown file includes at least a process S201 for detecting whether a software matching with an unknown file is locally installed; if the software matching with the unknown file is locally installed, then a process S202 may be executed; if not, then a process S206 may be executed.

According to some embodiments, the process S202 includes displaying a prompt for downloading the matching software. In one embodiment, the prompt includes a window that contains a download-control component For example, the download-control component is used to fetch a confirmation instruction for downloading the matching software.

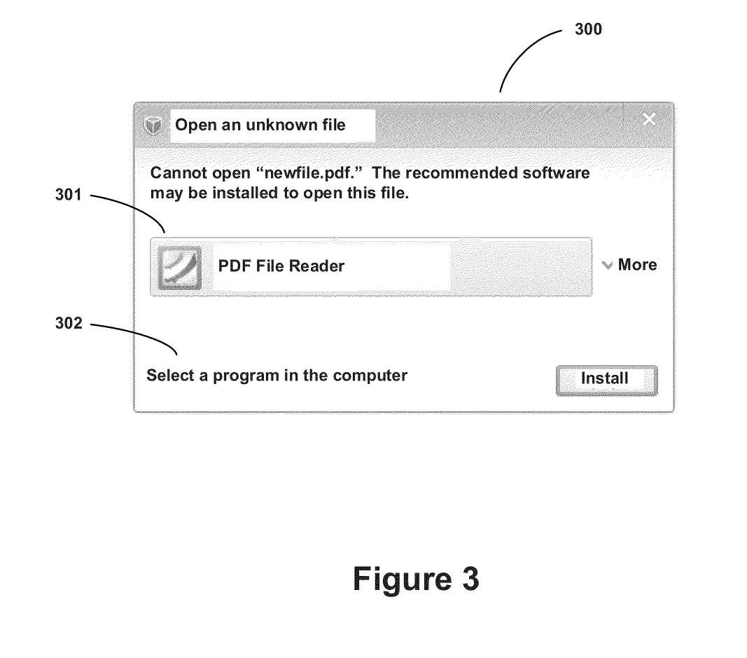

FIG. 3 is a simplified diagram of a prompt window showing one or more recommended software for opening an unknown file according to one embodiment of the present invention. This diagram is merely an example, which should not unduly limit the scope of the claims. One of ordinary skill in the art would recognize many variations, alternatives, and modifications.

As shown in FIG. 3, a prompt window 300 is displayed to show one or more recommended software for opening the unknown file that can be downloaded and/or installed, according to one embodiment, For example, the prompt window 300 includes an option list 301 of recommended software and another option 302 for selecting a program in the computer to open the unknown file. As an example, the option list 301 is more conspicuous than the option 302 so as to prompt a user to preferentially select an option corresponding to a certain recommended software from the list 301. In one embodiment, the font color, the font size, and/or the order of options in the option list 301 can be set to make the option list 301 more conspicuous.

Referring back to FIG. 2, the process S203 includes receiving a confirmation for downloading the matching software. In one embodiment, when a user clicks on the download-control component, a confirmation instruction to download the matching software is obtained.

As shown in FIG. 3, if the user selects an option corresponding to a particular recommended software from the list 301, a confirmation instruction is provided for downloading the matching software (i.e., the particular recommended software), according to certain embodiments. In another embodiment, if the user selects the option 302, a window of “select a program in the computer” provided by the operating system (e.g,, Windows) is displayed.

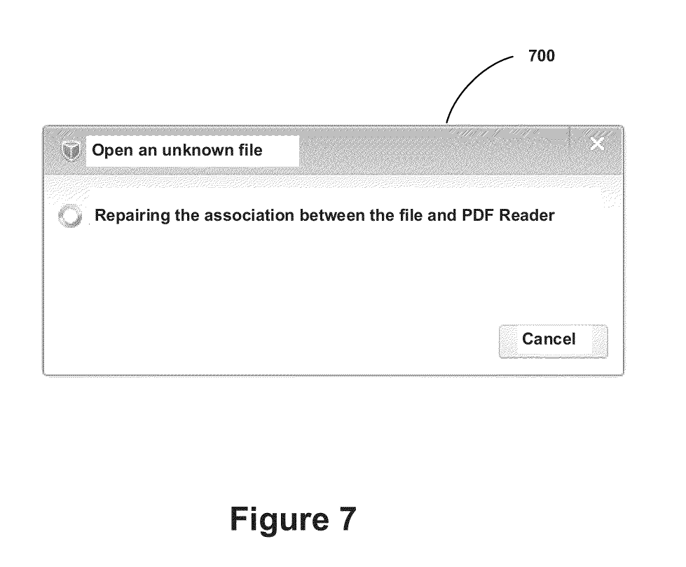

Referring back to FIG. 7, the process S204 includes downloading and installing the matching software, according to yet another embodiment. For example, the matching software is downloaded after the confirmation for downloading the software is received.

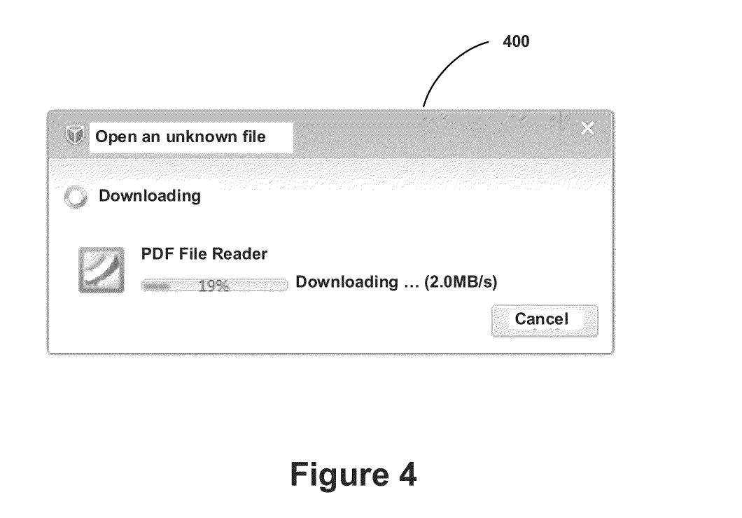

FIG. 4 is a simplified diagram of a prompt window showing that a software is being downloaded according to one embodiment of the present invention. This diagram is merely an example, which should not unduly limit the scope of the claims. One of ordinary skill in the art would recognize many variations, alternatives, and modifications. As shown in FIG. 4, a prompt window 400 is displayed to show that the software is being downloaded, in one embodiment. For example, the downloaded software can be installed automatically.

Referring to FIG. 2, the process S205 is executed after the installation of the downloaded software, according to certain embodiments. For example, the process S205 includes setting an association between a file type related to the unknown file and the downloaded software in the system registry, and providing an instruction to the operating system to open the unknown file.

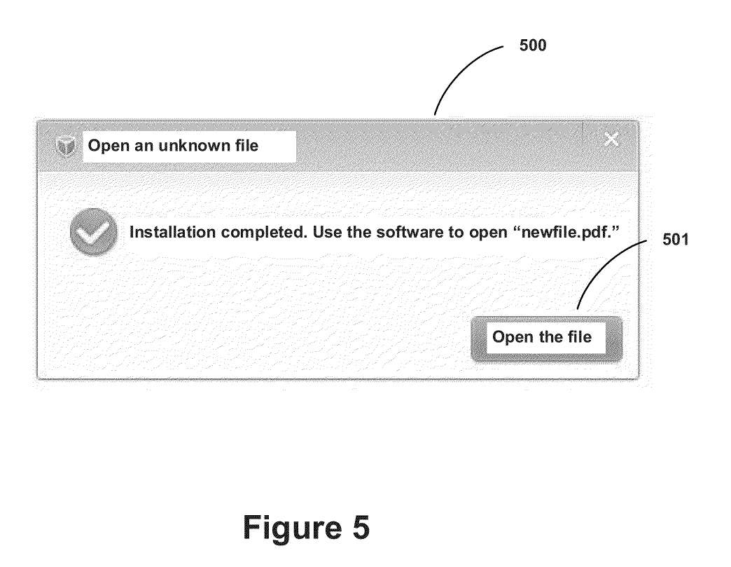

FIG. 5 is a simplified diagram of a prompt window showing the completion of installing a software according to one embodiment of the present invention. This diagram is merely an example, which should not unduly limit the scope of the claims. One of ordinary skill in the art would recognize many variations, alternatives, and modifications. As shown in FIG. 5, a prompt window 500 is displayed to show the completion of the installation, before the instruction to open the unknown file is sent to the operating system, according to one embodiment. For example, the prompt window 500 includes an option to open the unknown file 501. If the user selects the option 501, i.e., a. user instruction to open the unknown file using the downloaded software being received, an instruction to open the unknown file is sent to the operating system, in certain embodiments.

Referring back to FIG. 2, the process S206 includes displaying a prompt for repairing an association between the file type related to the unknown file and the installed software in the system registry, according to one embodiment For example, the prompt is a window including a repair-control component which can be used to receive a confirmation instruction for repairing the association between the file type of the unknown file and the matching software.

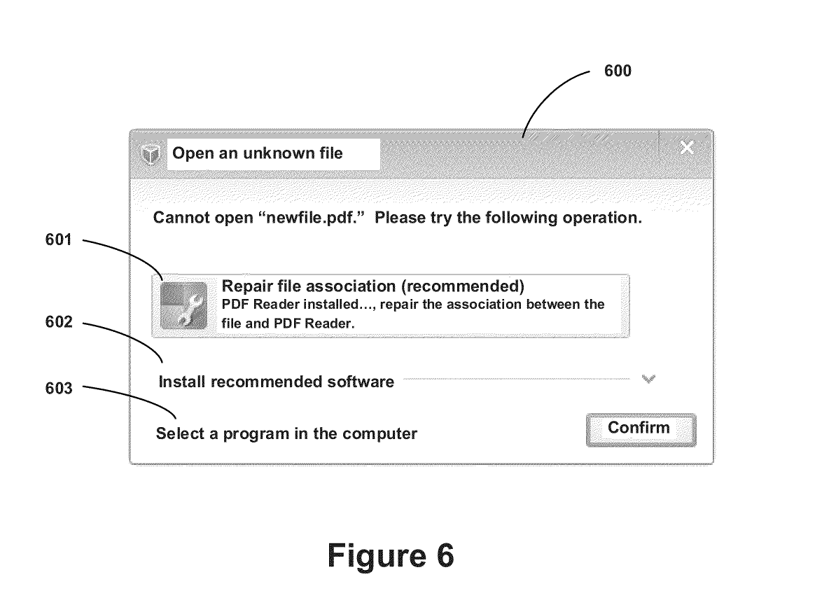

FIG. 6 is a simplified diagram of a prompt window for repairing an association between a type of an unknown file and a matching software according to one embodiment of the present invention, This diagram is merely an example, which should not unduly limit the scope of the claims. One of ordinary skill in the aft would recognize many variations, alternatives, and modifications. As shown in FIG. 6, a prompt window 600 is displayed and includes an option 601 to repair the association between the file type of the unknown file and the matching software, an option 602 to install a recommended software, and an option 603 to select a program in the computer to open the unknown file, according to some embodiments. As an example, the option 601 is more conspicuous than the options 602 and 603 so as to prompt a user to preferentially select the option 601. In one embodiment, the font color, the font size, and/or the order of options can be set to make the option 601 more conspicuous.

Referring to FIG. 2, the process S207 includes receiving a confirmation for repairing the association between the file type related to the unknown file and the locally installed software, in certain embodiments, For example, when a user clicks on the repair-control component, the user confirmation is received. As shown in FIG. 6, if the user selects the option 601, the user confirmation is received for repairing the association between the file type of the unknown file and the installed software.

The process S208 includes repairing the association between the file type of the unknown file and the installed software in the system registry, and providing an instruction to the operating system to open the unknown file, according to certain embodiments. For example, the association between the file type of the unknown file and the matching software in the system registry is repaired after receiving the confirmation instruction.

FIG. 7 is a simplified diagram of a prompt window showing that a process for repairing an association between a type of an unknown file and a matching software is ongoing according to one embodiment of the present invention. This diagram is merely an example, which should not unduly limit the scope of the claims. One of ordinary skill in the art would recognize many variations, alternatives, and modifications. As shown in FIG. 7, a prompt window 700 is displayed to show that the repairing process is ongoing, for example.

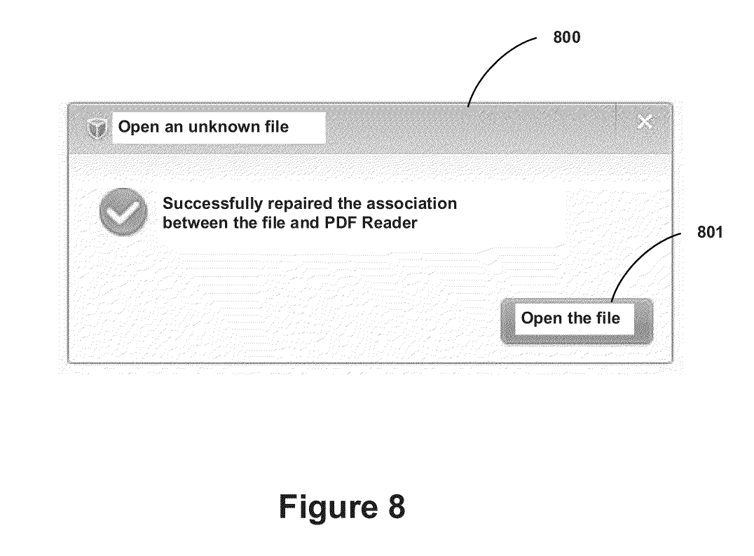

FIG. 8 is a simplified diagram of a prompt window showing that a process for repairing an association between a type of an unknown file and a matching software has completed according to one embodiment of the present invention. This diagram is merely an example, which should not unduly limit the scope of the claims. One of ordinary skill in the art would recognize many variations, alternatives, and modifications. In one embodiment, as shown in FIG. 8, upon the completion of repairing, a prompt window 800 which includes an option 801 to open the known file is displayed to indicate the repairing process has completed. For example, if the user selects the option 801, i.e., the user confirmation to open the unknown file using the installed software being received, the instruction to open the unknown file is then sent to the operating system.

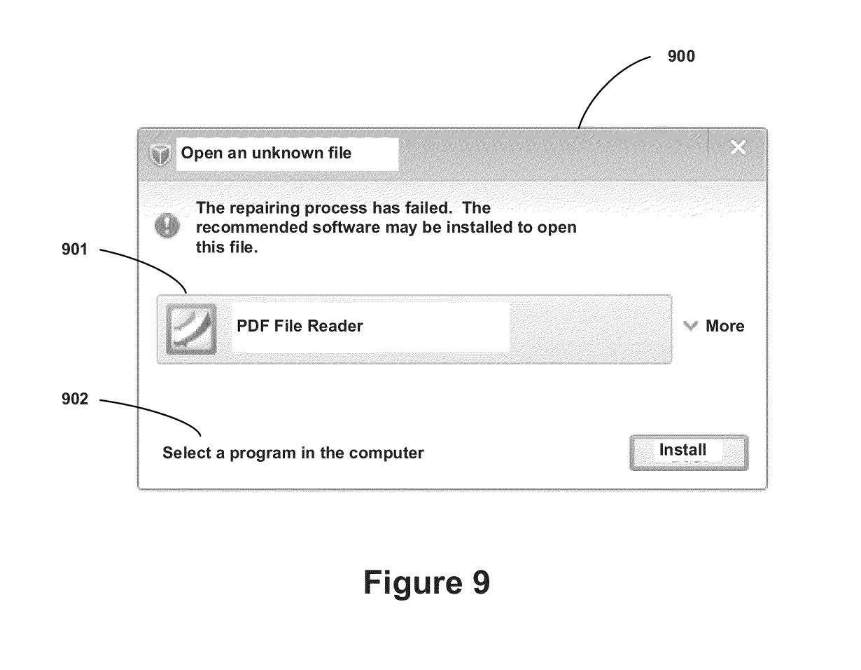

FIG. 9 is a simplified diagram of a prompt window showing that a process for repairing an association between a type of an unknown file and a matching software has failed according to one embodiment of the present invention. This diagram is merely an example, which should not unduly limit the scope of the claims. One of ordinary skill in the art would recognize many variations, alternatives, and modifications.

According to one embodiment, if the repairing process fails, as shown in FIG. 9, a prompt window 900 is displayed to indicate the failure of the repairing process. For example, the prompt window 900 includes an option list 901 of recommended software and another option 902 to select a program in the computer to open the known file, As an example, the option list 901 is more conspicuous than the option 902 to prompt the user to preferentially select an option corresponding to a certain recommended software within the option list 901. In another example, if the user selects an option corresponding to a particular recommended software within the option list 901, the user confirmation is obtained for downloading the matching software (i.e. the particular recommended software).

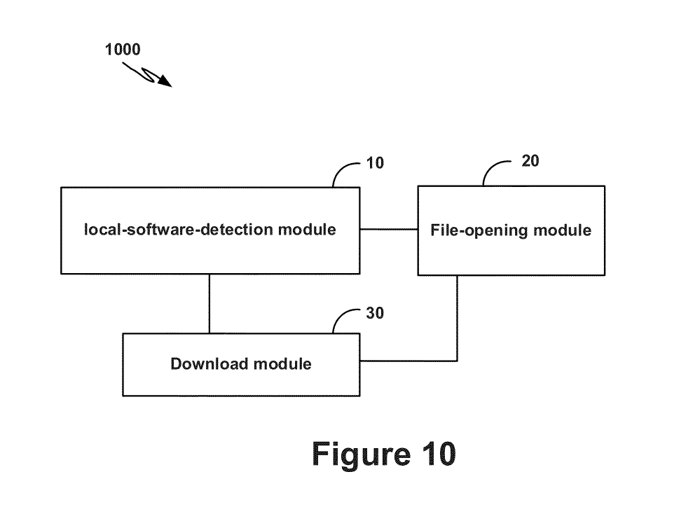

FIG. 111 is a simplified diagram showing a device for opening an unknown file according to one embodiment of the present invention. This diagram is merely an example, which should not unduly limit the scope of the claims. One of ordinary skill in the art would recognize many variations, alternatives, and modifications. As shown in FIG. 10, the device 1000 includes a local-software-detection module 10, a file-opening module 20, and a download module 30.

According to one embodiment, the local-software-detection module 10 is configured to detect whether a software matching with an unknown file is locally installed. When an operating system (e.g., Windows) receives an instruction to open an unknown file, the operating system may send an instruction to generate a. pop-up prompt window and a prompt window pops up in response. It may be indicated in the prompt window that the file cannot be opened, and two options may be provided—“use the Web service to find a correct program,” and “select a program from a list of installed programs.”

According to another embodiment, the local-software-detection module 10 is configured to detect whether an instruction to open an unknown file is received. For example, if the instruction to open an unknown file is received, the local-software-detection module 10 is configured to intercept a system instruction to generate a pop-up prompt window from the operating system (e.g., Windows) to prevent the prompt window from popping up. As an example, the local-software-detection module 10 is further configured to detect whether a software that matches with the unknown file has been installed locally.

Specifically, in some embodiments, information associated with a software that matches with the unknown file is obtained, including an identification of an application program that can open the unknown file. For example, the local-software-detection module 10 is configured to detect whether configuration files of locally installed software contain extensions related to the unknown file. As an example, if the configuration files of a particular software contain such extensions, this software matches with the unknown file.

Furthermore, the local-software-detection module 10 is configured to detect whether the matching software is included in a software list within a system registry or included in an application list within the Start menu, according to another embodiment. For example, if the matching software is found in either the software list or the application list, the matching software has been locally, installed.

According to another embodiment, the file-opening module 20 is configured, in response to the software being locally installed, to open the unknown file with the installed software and, in response to the software not being locally installed, open the unknown file with the downloaded software.

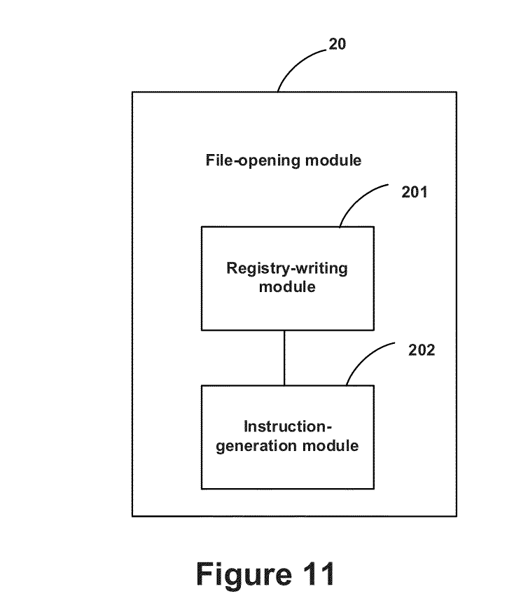

FIG. 11 is a simplified diagram showing certain components of the file-opening module 20 as part of the device 1000 according to one embodiment of the present invention. This diagram is merely an example, which should not unduly limit the scope of the claims. One of ordinary skill in the art would recognize many variations, alternatives, and modifications. As shown in FIG. 11 the file-opening module includes a registry-writing module 201 and an instruction-generation module 202.

According to one embodiment, the registry-writing module 201 is configured, in response to the software being locally installed, to repair an association between a file type related to the unknown file and the installed software in a registry of an operating system, For example, the instruction-generation module 202 is configured to provide an instruction to the operating system to open the unknown file.

According to another embodiment, an association between the file type of the unknown file and the matching software within the system registry is repaired, and then an instruction is sent to the operating system to open the unknown file. When the operating system (e.g., Windows) receives the instruction to open a certain file, the operating system may search in the system registry for a software associated with the type of the file to be opened, and run the associated software to open the file. For example, the registry-writing module 201 is configured to repair the association between the file type of the unknown file and the matching software in the system registry. In another example, the instruction-generation module 202 is configured to send an instruction to open the unknown file to the operating system (e.g., Windows) which runs the matching software to open the unknown file. in one embodiment, in response to a failure of repairing the association between the file type related to the unknown file and the installed software in the system registry, the matching software is downloaded, and the unknown file is then opened using the downloaded software.

Referring hack to Figure l 0, the download module 30 is configured, in response to the software not being locally installed, to download the software, according to certain embodiments. For example, information associated with relationship between file types and corresponding software the software capable of opening files of one or more file types) is saved in advance. As an example, the download module 30 is configured to locate a software that corresponds to the file type of the unknown file and obtain the identification information of the matching software based on the information associated with the relationship between file types and corresponding software.

In another embodiment, information associated with relationship between software identification information and corresponding download addresses is saved in advance. For example, the download module 30 is configured to locate the download address that corresponds to the identification information of the matching software and download the matching software from the located download address.

In yet another embodiment, the file-opening module 20 is further configured, in response to the matching software not being locally installed, to download the matching software and open the unknown file using the downloaded software.

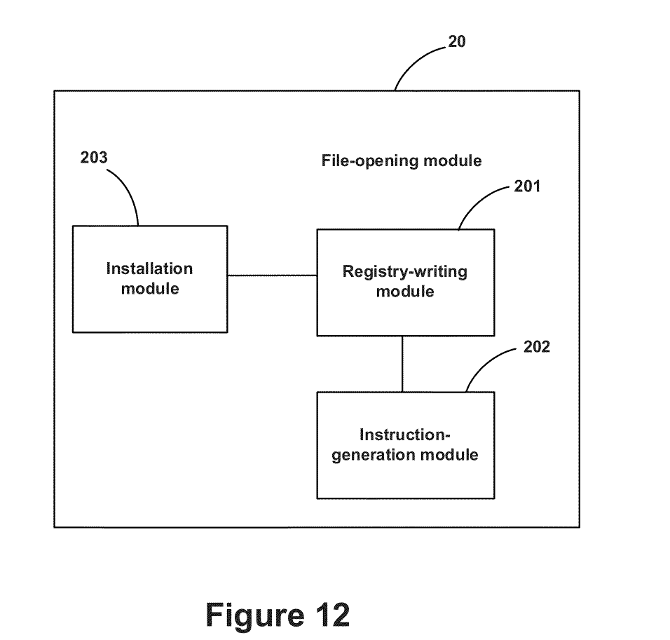

FIG. 12 is a simplified diagram showing certain components of the file-opening module 20 as part of the device 1000 according to another embodiment of the present invention. This diagram is merely an example, which should not unduly limit the scope of the claims. One of ordinary skill in the art would recognize many variations, alternatives, and modifications. As shown in FIG. 12, the file-opening module further includes an installation module 203 in addition to the registry-writing module 201 and the instruction-generation module 202.

According to one embodiment, the installation module 203 is configured, in response to the software not being locally installed, to install the downloaded software. For example, the registry-writing module 201 is further configured, in response to the software not being locally installed, to set the association between the file type related to the unknown file and the downloaded software in the system registry, In another example, the instruction-generation module 202 is further configured to provide an instruction to the operating system to open the unknown file.

According to another embodiment, the download module 30 is further configured, in response to a failure of repairing the association between the file type related to the unknown file and the installed software in the system registry, to download the software. For example, the file-opening module 20 is further configured, in response to a failure of repairing the association between the file type related to the unknown file and the installed software in the system registry, to open the unknown file using the downloaded software.

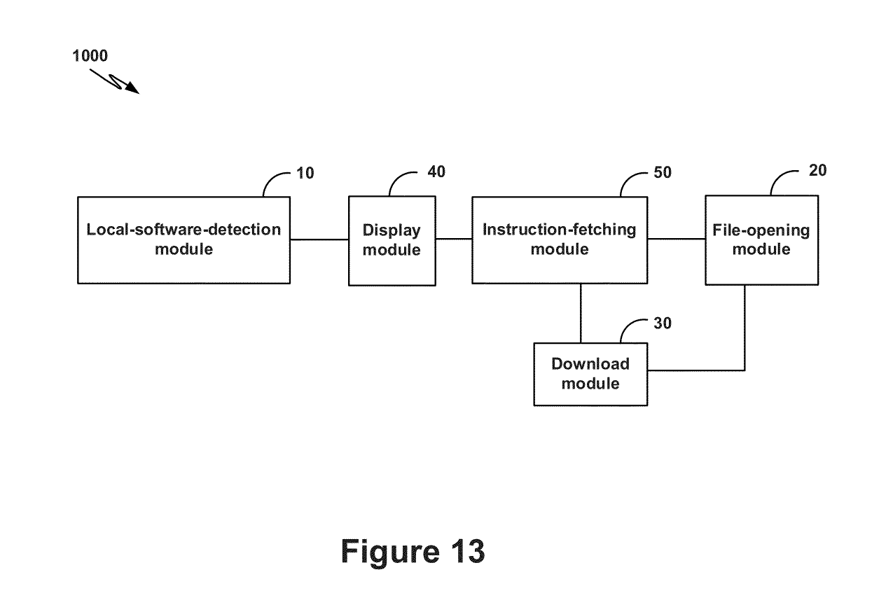

FIG. 13 is a simplified diagram showing a device for opening an unknown file according to another embodiment of the present invention. This diagram is merely an example, which should not unduly limit the scope of the claims. One of ordinary skill in the art would recognize many variations, alternatives, and modifications. As Shown in FIG. 13, the device 1000 further includes a display module 40 and an instruction-fetching module 50, in addition to the local-software-detection module 10, the file-opening module 20 and the download module 30,

According to one embodiment, the display module 40 is configured to display a prompt fur repairing the association between the file type related to the unknown file and the installed software in the system registry, e.g., before the registry-writing module 201 repairs the association between the file type of the unknown file and the matching software in the system registry. For example, the prompt is a window including a repair-control component which can be used to receive a confirmation instruction for repairing the association between the file type of the unknown file and the matching software.

According to another embodiment, the instruction-fetching module 50 is configured to receive a confirmation for repairing the association between the file type related to the unknown file and the installed software in the system registry, e.g., before the registry-writing module 201 repairs the association between the file type of the unknown file and the matching software in the system registry. For example, when a user clicks on the repair-control component, the instruction-fetching module 50 is configured to receive the user confirmation.

In one embodiment, the display module 40 is further configured to display a prompt for downloading the matching software, e.g., before the download module 30 downloads the matching software. For example, the prompt includes a window that contains a download-control component. In another example, the download-control component is used to fetch a confirmation instruction for downloading the matching software.

In another embodiment, the instruction-fetching module 50 is further configured to receive a confirmation for downloading the software, e.g., before the download module 30 downloads the matching software. For example, when a user clicks on the download-control component, the instruction-fetching module 50 is configured to receive the user confirmation for downloading the matching software.

According to one embodiment, a method is provided for opening an unknown file. For example, whether a software matching with an unknown file is locally installed is detected; in response to the software being locally installed, the unknown file is opened using the installed software; and in response to the software not being locally installed, the software is downloaded and the unknown file is opened using the downloaded software. For example, the method is implemented according to at least FIG. 1 and/or FIG. 2.

According to another embodiment, a device for opening an unknown file includes a local-software-detection module, a download module, and a file-opening module. The local-software-detection module is configured to detect whether a software matching with an unknown file is locally installed. The download module is configured, in response to the software not being locally installed, to download the software. The file-opening module is configured, in response to the software being locally installed, to open the unknown file with the installed software and, in response to the software not being locally installed, open the unknown file with the downloaded software. For example, the device is implemented according to at least FIG. 10 and/or FIG. 13.

According to yet another embodiment, a method is provided for opening an unknown file. For example, whether a software matching with an unknown file is locally installed is detected; in response to the software being locally installed, the unknown file is opened using the installed software; and in response to the software not being locally installed, the software is downloaded and the unknown file is opened using the downloaded software. The opening the unknown file using the installed software include, repairing an association between a file type related to the unknown file and the installed software in a registry of an operating system; providing an instruction to the operating system to open the unknown file; and in response to failing to repair the association between the file type related to the unknown file and the installed software in the registry of the operating system, downloading the software and opening the unknown file using the downloaded software. The repairing an association between a file type related to the unknown file and the installed software in a registry of an operating system includes: displaying a prompt fir repairing the association between the file type related to the unknown file and the installed software in the registry of the operating system; and receiving a confirmation for repairing the association between the file type related to the unknown file and the installed software, The opening the unknown file using the downloaded software includes: installing the downloaded software; setting an association between a file type related to the unknown file and the downloaded software; and providing an instruction to the operating system to open the unknown file. The downloading the software includes: displaying a prompt for downloading the software; and receiving a confirmation for downloading the software. For example, the method is implemented according to at least FIG. 1, FIG. 2, FIG. 3, FIG. 4, FIG. 5, FIG. 6, FIG. 7, FIG. 8, and/or FIG. 9.

In one embodiment, a device for opening an unknown file includes a local-so are-detection module, a download module, a file-opening module, a display module, and an instruction-fetching module. The local-software-detection module is configured to detect whether a software matching with an unknown file is locally installed. The download module is configured, in response to the software not being locally installed, to download the software. The file-opening module is configured, in response to the software being locally installed, to open the unknown file with the installed software and, in response to the software not being locally installed, open the unknown file with the downloaded software. The display module is configured to display a prompt for repairing an association between a file type related to the unknown file and the installed software in a registry of an operating system and display a prompt for downloading the software. The instruction-fetching module is configured to receive a confirmation for repairing the association between the file type related to the unknown file and the installed software in the registry of the operating system and receive a confirmation for downloading the software. The file-opening module includes a registry-writing module, an instruction-generation module, and an installation module. The registry-writing module is configured, in response to the software being locally installed, to repair the association between the file type related to the unknown file and the installed software in the registry of the operating system and, in response to the software not being locally installed, set the association between the file type related to the unknown file and the downloaded software in the registry of the operating system. The instruction-generation module is configured to provide an instruction to the operating system to open the unknown file. The installation module is configured, in response to the software not being locally installed, to install the downloaded software. The download module is further configured, in response to failing to repair the association between the file type related to the unknown file and the installed software in the registry of the operating system, to download the software. The file-opening module is further configured, in response to failing to repair the association between the file type related to the unknown file and the installed software in the registry of the operating system, to open the unknown file using the downloaded software. For example, the device is implemented according to at least FIG. 3, FIG. 4, FIG. 5, FIG. 6, FIG. 7, FIG. 8, FIG. 9, FIG. 10, FIG. 11, FIG. 12, and/or FIG. 13.

In another embodiment, a non-transitory computer readable storage medium comprises programming instructions for opening an unknown file. The programming instructions are configured to cause a processing system to execute operations comprising: detecting whether a software matching with an unknown file is locally installed; in response to the software being locally installed, opening the unknown file using the installed software; and in response to the software not being locally installed, downloading the software and opening the unknown file using the downloaded software. For example, the storage medium is implemented according to at least FIG. 1 and/or FIG. 2.

In yet another embodiment, a computer-implemented system for opening an unknown file includes one or more data processors and a computer-readable storage medium. The computer-readable storage medium is encoded with instructions for commanding the data processors to execute operations including: detecting whether a software matching with an unknown file is locally installed; in response to the software being locally installed, opening the unknown file using the installed software; and in response to the software not being locally installed, downloading the software and opening the unknown file using the downloaded software. For example, the system is implemented according to at least FIG. 1 and/or FIG. 2.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits, In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A processor-implemented method for opening an unknown file, the method comprising:
detecting, using one or more data processors, whether a software matching with an unknown file is locally installed:
in response to the software being locally installed, opening the unknown file using the installed software; and
in response to the software not being locally installed,
downloading, using the one or more data processors, the software; and
opening the unknown file using the downloaded software.

2. The method of claim 1, wherein the opening the unknown file using the installed software includes:
repairing an association between a file type related to the unknown file and the installed software in a registry of an operating system; and
providing an instruction to the operating system to open the unknown file.

3. The method of claim 2, further comprising:
in response to failing to repair the association between the file type related to the unknown file and the installed software in the registry of the operating system, downloading the software; and
opening the unknown file using the downloaded software.

4. The method of claim 3, further comprising:
displaying a prompt for repairing the association between the file type related to the unknown file and the installed software in the registry of the operating system; and
receiving a confirmation for repairing the association between the file type related to the file and the installed software.

5. The method of claim 1, wherein the opening the unknown file using the downloaded software includes:
installing the downloaded software;
setting an association between a file type related to the unknown file and the downloaded software in a registry of an operating system; and
providing an instruction to the operating system to open the unknown file.

6. The method of claim 5, further comprising:
displaying a prompt for downloading the software; and
receiving a confirmation for downloading the software.

7. A device for opening an unknown file, the device comprising:
a local-software-detection module configured to detect whether a software matching with an unknown file is locally installed;
a download module configured, in response to the software not being locally installed, to download the software; and
a file-opening module configured, in response to the software being locally installed, to open the unknown file with the installed software and, in response to the software not being locally installed, open the unknown file with the downloaded software.

8. The device of claim 7, wherein the file-opening module includes:
a registry-writing module configured, in response to the software being locally installed, to repair an association between a file type related to the unknown file and the installed software in a registry of an operating system; and
an instruction-generation module configured to provide an instruction to the operating system to open the unknown file.

9. The device of claim 8, wherein the file-opening module further includes:
an installation module configured, in response to the software not being locally installed, install the downloaded software;
wherein the registry-writing module is further configured, in response to the software not being locally installed, to set the association between the file type related to the unknown file and the downloaded software in the registry of the operating system.

10. The device of claim 9, wherein:
the download module is further configured, in response to failing to repair the association between the file type related to the unknown file and the installed software in the registry of the operating system, to download the software; and
the file-opening module is further configured, in response to failing to repair the association between the file type related to the unknown file and the installed software in the registry of the operating system, to open the unknown file using the downloaded software.

11. The device of claim 10, wherein the device further includes:
a display module configured to display a prompt for repairing the association between the file type related to the unknown file and the installed software in the registry of the operating system; and
an instruction-fetching module configured to receive a confirmation for repairing the association between the file type related to the unknown file and the installed software in the registry of the operating system.

12. The device of claim 7, further comprising:
a display module configured to display a prompt for downloading the software;
an instruction-fetching module configured to receive a confirmation for downloading the software.

13. A processor-implemented method for opening an unknown file, the method comprising:
detecting, using one or more data processors, ether a software matching with an unknown file is locally installed;
in response to the software being locally installed, opening the unknown file using the installed software: and in response to the software not being locally installed,
downloading, using the one or more data processors, the software; and
opening the unknown file using the downloaded software;
wherein the opening the unknown file using the installed software includes:
repairing an association between a file type related to the unknown file and the installed software in a registry of an operating system;
providing an instruction to the operating system to open the unknown file;
in response to failing to repair the association between the file type related to the unknown file and the installed software in the registry of the operating system,
downloading the software; and
opening the unknown file using the downloaded software;
wherein the repairing an association between a file type related to the unknown file and the installed software in a registry of an operating system includes:
displaying a prompt for repairing the association between the file type related to the unknown file and the installed software in the registry of the operating system; and
receiving a confirmation for repairing the association between the file type related to the unknown file and the installed software;
wherein the opening the unknown file using the downloaded software includes:
installing the downloaded software;
setting an association between a file type related to the unknown file and the downloaded software; and
providing an instruction to the operating system to open the unknown file;
wherein the downloading the software includes:
displaying a prompt for downloading the software; and
receiving a confirmation for downloading the software.

14. A device for opening an unknown file, the device comprising:
a local-software-detection module configured to detect whether a software matching with an unknown file is locally installed;
a download module configured, in response to the software not being locally installed, to download the software; and
a file-opening module configured, in response to the software being locally installed, to open the unknown file with the installed software and, in response to the software not being locally installed, open the unknown file with the downloaded software;
a display module configured to display a prompt for repairing an association between a file type related to the unknown file and the installed software in a registry of an operating system and display a prompt for downloading the software; and
an instruction-fetching module configured to receive a confirmation for repairing the association between the fife type related to the unknown file and the installed software in the registry of the operating system and receive a confirmation for downloading the software;
wherein the file-opening module includes:
a registry-writing module configured, in response to the software being locally installed, to repair the association between the file type related to the unknown file and the installed software in the registry of the operating system and, in response to the software not being locally installed, set the association between the file type related to the unknown file and the downloaded software in the registry of the operating system;
an instruction-generation module configured to provide an instruction to the operating system to open the unknown file: and
an installation module configured, in response to the software not being locally installed, to install the downloaded software;
wherein:
the download module is further configured, in response to failing to repair the association between the file type related to the unknown file and the installed software in the registry of the operating system, to download the software; and
the file-opening module is further configured, in response to failing to repair the association between the file type related to the unknown file and the installed software in the registry of the operating system, to open the unknown file using the downloaded software.

15. A non-transitory computer readable storage medium comprising programming instructions for opening an unknown file, the programming instructions configured to cause a processing system to execute operations comprising:
detecting whether a software matching with an unknown file is locally installed;
in response to the software being locally installed, opening the unknown file using the installed software; and
in response to the software not being locally installed,
downloading the software; and
opening the unknown file using the downloaded software.

16. A computer-implemented system for opening an unknown file, said system comprising:
one or more data processors; and
a computer-readable storage medium encoded with instructions for commanding the data processors to execute operations including:
detecting whether a software matching with an unknown file is locally installed;
in response to the software being locally installed, opening the unknown file using the installed software; and
in response to the software not being locally installed,
downloading the software; and
opening the unknown file using the downloaded software.
